(19) United States
(12) Patent Application Publication
(10) Pub. No.: US 2010/0083080 A1
(43) Pub. Date: Apr. 1, 2010

(54) Whole table referencing

(75) Inventor: Peter William Rapp, Pittsburgh, PA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Inc.

(21) Appl. No.: 12/286,631

(22) Filed: Sep. 30, 2008

(51) Int. Cl. G06F 17/00

(52) U.S. Cl. 715/212

(57) ABSTRACT

Whole table referencing without explicit cell ranges is disclosed. In some embodiments, an identifier associated with a table may be employed as a table reference that refers to at least all body cells of the table. In some embodiments, such an identifier remains a valid table reference that refers to at least all body cells of the table through table size variations.

### BACKGROUND OF THE INVENTION

In existing spreadsheet applications, a table reference requires an explicit cell range to be specified. FIG. 1A illustrates an example of a data table that is named “Fruit Fun”. FIG. 1B and FIG. 1C each illustrates a cell in a formula editing mode that includes a table reference as an argument of a function being entered into the formula. As depicted in FIG. 1B, a reference to all of the body cells of the table (i.e., the cells other than header row/column cells), Fruit Fun::B2:D6, requires an explicit cell range. Similarly, as depicted in FIG. 1C, a reference to all body and header cells of the table, Fruit Fun::A1:D6, requires an explicit cell range to be specified. With such types of table references, if the dimensions of the referenced table change (e.g., if rows and/or columns of cells are deleted from and/or added to the table), the cell ranges in the table references would have to be manually updated to continue referring to the whole referenced table.

### BRIEF DESCRIPTION OF THE DRAWINGS

Various embodiments of the invention are disclosed in the following detailed description and the accompanying drawings.

FIG. 1A illustrates an example of a data table.

FIG. 1B illustrates a prior art table reference.

FIG. 1C illustrates a prior art table reference.

FIG. 2A illustrates an example of a data table.

FIG. 2B illustrates address tabs with the data table of FIG. 2A.

FIG. 2C illustrates an embodiment of a table reference.

FIG. 2D illustrates an embodiment of a table reference.

FIG. 3 illustrates an embodiment of a process for referring to a table.

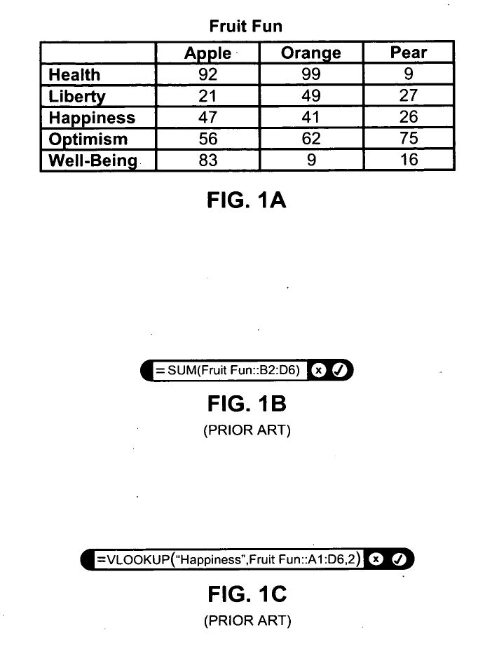

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, the term “cell” refers to a cell associated with at least standard spreadsheet functionality. The term “at least standard spreadsheet functionality” in the context of a cell includes the ability to define the content of one cell in such a way that the content of the one cell is determined based at least in part on the content of one or more other cells, and the content of the one cell is updated automatically without further human action if the content of one or more of the one or more other cells is changed. As used herein, the term “host cell” refers to a cell in a formula editing mode, i.e., a cell into which a formula is being entered. In some embodiments, cells in a spreadsheet application are organized into one or more individual tables or table objects, each of which includes a desired number of rows and columns of cells. In such cases, a sheet or canvas of a spreadsheet document may include a desired number of table objects as well as any desired number of other objects such as charts, graphs, images, etc. Although in some of the examples described herein the cells of a spreadsheet application are organized into such table objects, the techniques described herein may be similarly employed with respect to other cell configurations or organizations, such as the (seemingly) infinite single grid or table of cells in each sheet of some typical spreadsheet applications that includes an unlimited (or very large) number of rows and columns of cells. Although many of the examples provided herein are with respect to a spreadsheet application, the techniques described herein may be similarly employed with respect to any application, spreadsheet or otherwise.

Whole table referencing without explicit cell ranges is disclosed. In some embodiments, the body cells of a table or all cells, including both body and header cells, of a table may be referred to by an identifier associated with the table and without use of any explicit cell ranges. Such a table reference remains valid and invariant even when the dimensions of an associated table are changed, e.g., as rows and/or columns of cells are deleted from and/or added to the table. In some embodiments, the context in which such a table reference is employed determines whether the table reference refers to just the body cells of the table or both the body and header cells of the table.

In various embodiments, a table reference that refers to a particular table may include a table identifier associated with the table, a sheet or canvas identifier associated with the sheet or canvas that includes the table, and/or a document identifier associated with the document that includes the table, for example, depending on whether the table reference is made within the same sheet or canvas that includes the table, in a different sheet or canvas in the same document, or in a different document. For example, a table reference to a table named “Grades” that is included in a sheet or canvas named “Fall 2008” and in a document named “Programming 101” may comprise any appropriate permutation, such as “Grades”, “Fall 2008::Grades”, “Programming 101::Grades”, and “Programming 101::Fall 2008::Grades”, that uniquely identifies the table in the context in which the reference is made.

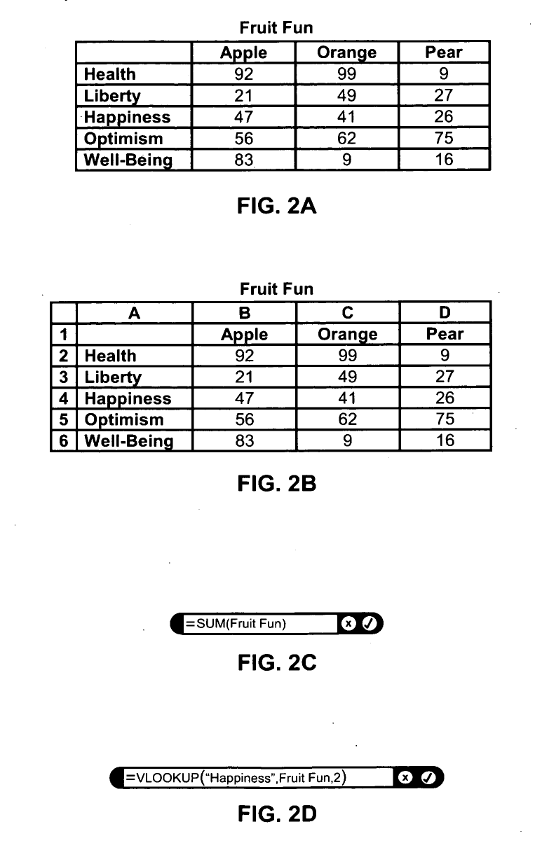

FIG. 2A illustrates an embodiment of a data table that is named “Fruit Fun”. FIG. 2B illustrates address tabs with the data table of FIG. 2A, which in some embodiments, may be selected to be turned off as in FIG. 2A. The table in the given examples includes a row of column header cells (row 1), a column of row header cells (column A), and five rows and three columns of body cells (B2:D6). The body cells contain the data of the table. Like the address tabs, the header cells may be employed to refer to one or more body cells of the table. In various embodiments, a table may or may not include header cells.

FIG. 2C and FIG. 2D each illustrates an embodiment of a cell in a formula editing mode that includes a table reference as an argument of a function being entered into the formula. In FIG. 2C, the table name “Fruit Fun” is employed to refer to all of the body cells of the table, i.e., cells B2:D6. In FIG. 2D, the table name “Fruit Fun” is employed to refer to all (body and header) cells of the table, i.e. cells A1:D6. In some embodiments, the context in which a table reference is employed determines whether the table reference refers to just the body cells of the table or all (body and header) cells of the table. For example, the SUM function in FIG. 2C interprets the whole table reference “Fruit Fun” to refer to just the body cells of the table, and the VLOOKUP function (which looks for a value (“Happiness” in the given example) in the leftmost column of a table and returns a value in the same row from a specified column (2 in the given example)) in FIG. 2D interprets the whole table reference “Fruit Fun” to refer to all (body and header) cells of the table.

A whole table reference without an explicit specification of a cell range is not only simpler to specify but is maintainable through table size variations. Such a whole table reference may be employed in any appropriate context, such as in a formula, as a function argument, in the source data definition of a chart or graph, etc. In some embodiments, a table reference may be represented in a formula (or other context) with a token, i.e., an atomic user interface object, rather than as plain text.

Like with cell or other references in spreadsheet applications, any context (e.g., a cell, formula, function, data source definition, graph, chart, etc.) that includes a table reference is dynamically updated (e.g., a formula is recalculated) in response to changes in the table such that current table values and/or properties are reflected in an associated calculation or computation. In some embodiments, for example, changes are pushed from a table object to all references of the table to facilitate the dynamic update.

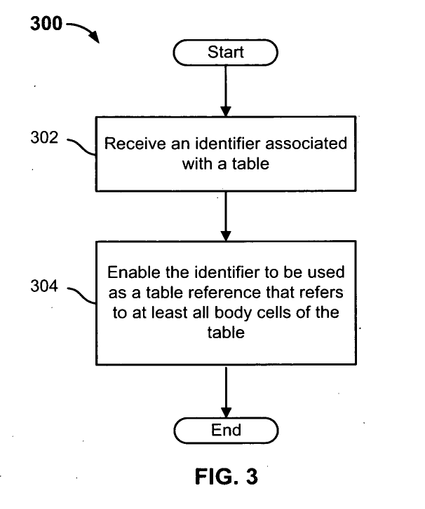

FIG. 3 illustrates an embodiment of a process for referring to a table. Process 300 starts at 302 at which an identifier that uniquely specifies a table in a given context is received. In various embodiments, the identifier received at 302 may include a table identifier associated with the table, a sheet or canvas identifier associated with the sheet or canvas that includes the table, and/or a document identifier associated with the document that includes the table. At 304, the identifier received at 302 is enabled to be used as a table reference that refers to at least all body cells of the table. The identifier remains a valid table reference that refers to at least all body cells of the table through table size variations. In some embodiments, the identifier is enabled to be used as a table reference that refers to all cells of the table, including both body and header cells. In some embodiments, the context in which the identifier is used as a table reference determines whether it refers to just the body cells of the table or all cells, including both body and header cells, of the table. Process 300 subsequently ends.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A computer program product for referring to a table, the computer program product being embodied in a computer readable storage medium and comprising computer instructions for:
receiving an identifier associated with a table; and
enabling the identifier to be used as a table reference that refers to at least all body cells of the table without requiring that a cell range associated with said at least all body cells of the table be specified explicitly.

2. The computer program product recited in claim 1, wherein the identifier remains a valid table reference that refers to at least all body cells of the table through table size variations.

3. The computer program product recited in claim 1, further comprising computer instructions for enabling the identifier to be used as a table reference that refers to both body and header cells of the table.

4. The computer program product recited in claim 1, wherein the identifier comprises one or more of a table identifier associated with the table, a sheet or canvas identifier associated with a sheet or canvas that includes the table, and a document identifier associated with a document that includes the table.

5. The computer program product recited in claim 1, further comprising computer instructions for determining whether the table reference refers to all cells of the table or just all body cells of the table based on a context in which the table reference is used.

6. The computer program product recited in claim 5, wherein the determination is based on one or more of the following: a formula, a function, a function argument, and a source data definition with respect to which the table reference is used.

7. The computer program product recited in claim 1, wherein the table comprises one or more body cells, one or more header cells, or both.

8. A system for referring to a table, comprising:
a processor configured to:
receive an identifier associated with a table; and
enable the identifier to be used as a table reference that refers to at least all body cells of the table without requiring that a cell range associated with said at least all body cells of the table be specified explicitly; and
a memory coupled to the processor and configured to provide the processor with instructions.

9. The system recited in claim 8, wherein the identifier remains a valid table reference that refers to at least all body cells of the table through table size variations.

10. The system recited in claim 8, wherein the processor if further configured to enable the identifier to be used as a table reference that refers to both body and header cells of the table.

11. The system recited in claim 8, wherein the identifier comprises one or more of a table identifier associated with the table, a sheet or canvas identifier associated with a sheet or canvas that includes the table, and a document identifier associated with a document that includes the table.

12. The system recited in claim 8, wherein the processor is further configured to determine whether the table reference refers to all cells of the table or just all body cells of the table based on a context in which the table reference is used.

13. The system recited in claim 12, wherein the determination is based on one or more of the following: a formula, a function, a function argument, and a source data definition with respect to which the table reference is used.

14. The system recited in claim 8, wherein the table comprises one or more body cells, one or more header cells, or both.

15. A method for referring to a table, comprising:
receiving an identifier associated with a table; and
enabling the identifier to be used as a table reference that refers to at least all body cells of the table without requiring that a cell range associated with said at least all body cells of the table be specified explicitly.

16. The method recited in claim 15, wherein the identifier remains a valid table reference that refers to at least all body cells of the table through table size variations.

17. The method recited in claim 15, further comprising enabling the identifier to be used as a table reference that refers to both body and header cells of the table.

18. The method recited in claim 15, wherein the identifier comprises one or more of a table identifier associated with the table, a sheet or canvas identifier associated with a sheet or canvas that includes the table, and a document identifier associated with a document that includes the table.

19. The method recited in claim 15, further comprising determining whether the table reference refers to all cells of the table or just all body cells of the table based on a context in which the table reference is used.

20. The method recited in claim 19, wherein the determination is based on one or more of the following: a formula, a function, a function argument, and a source data definition with respect to which the table reference is used.
